(19) United States
(12) Patent Application Publication
(10) Pub. No.: US 2009/0114674 A1
(43) Pub. Date: May 7, 2009

(54) AUTOMATIC CONTINUOUS SPRAYER AND RELATED METHOD THEREOF

(76) Inventor: LEE-WEI CHOU, Pinole, CA (US)

Correspondence Address: LEONG C LEI, PMB # 1008, 1867 YGNACIO VALLEY ROAD, WALNUT CREEK, CA, 94598, US

(21) Appl. No.: 11/934,796

(22) Filed: Nov. 5, 2007

(51) Int. Cl. B67D 5/40; G01F 11/00

(52) U.S. Cl. 222/1; 222/383.1

(57) ABSTRACT

The sprayer of the present invention has a conventional first lever and a second lever with continuous teeth along an edge. When the first lever is engaged, the second lever drives a gear set which in turn engages a rotatable piece inside a gravity wheel. Two blocks at the ends of the rotatable piece, as the rotatable piece turns, intermittently press some ratchets inside the gravity wheel to turn the gravity wheel as well. The gravity wheel in turn drives an eccentric gear with a shaft attached to it so that the shaft is put into continuous back-and-forth movement to work on a pump of the sprayer. As such, a number of sprays are produced continuously with a single engagement of the first lever.

### TECHNICAL FIELD OF THE INVENTION

The present invention generally relates to sprayers, and more particularly to a sprayer capable of producing continuous sprays with a single engagement of the lever.

### DESCRIPTION OF THE PRIOR ART

Sprayers are commonly found in daily life for spraying deodorants or detergents or other types of liquids. A conventional sprayer, as shown in FIG. 1, is operated by manually exercising an external force on a lever of the sprayer to pressurize the liquid contained in a container to flow through a dip tube and then spray in a mist.

Despite that many improvements have been disclosed for the sprayer, most of them still produce a single spray when the lever is engaged once. If a larger amount of mist is required, the user has to continuously engage the lever. This is a laborious process and the speed in producing the required amount of mist is also slow.

### SUMMARY OF THE INVENTION

The primary purpose of the present invention is to provide a novel sprayer and a related method.

The sprayer of the present invention has a conventional first lever and a second lever with continuous teeth along an edge. When the first lever is engaged, the second lever drives a gear set which in turn engages a rotatable piece inside a gravity wheel. Two blocks at the ends of the rotatable piece, as the rotatable piece turns, intermittently press some ratchets inside the gravity wheel to turn the gravity wheel as well. The gravity wheel in turn drives an eccentric gear with a shaft attached to it so that the shaft is put into continuous back-and-forth movement to work on a pump of the sprayer. As such, a number of sprays are produced continuously with a single engagement of the first lever.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view showing the operation of a conventional sprayer.

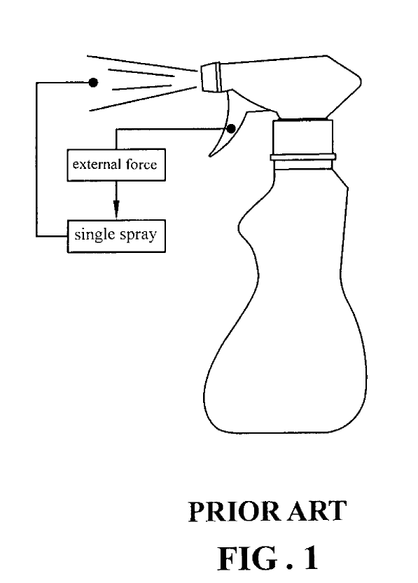

FIG. 2 is a schematic view showing the operation principle behind the present invention.

FIG. 3 is a schematic view showing the process of transforming external linear pressure into continuously back-and-force force.

FIG. 4 is a profile view showing a sprayer according to an embodiment of the present invention.

FIG. 5 is a schematic view showing the inside of the sprayer of FIG. 4 before a first lever is engaged.

FIG. 6 is a schematic view showing the inside of the sprayer of FIG. 4 after a first lever is engaged.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

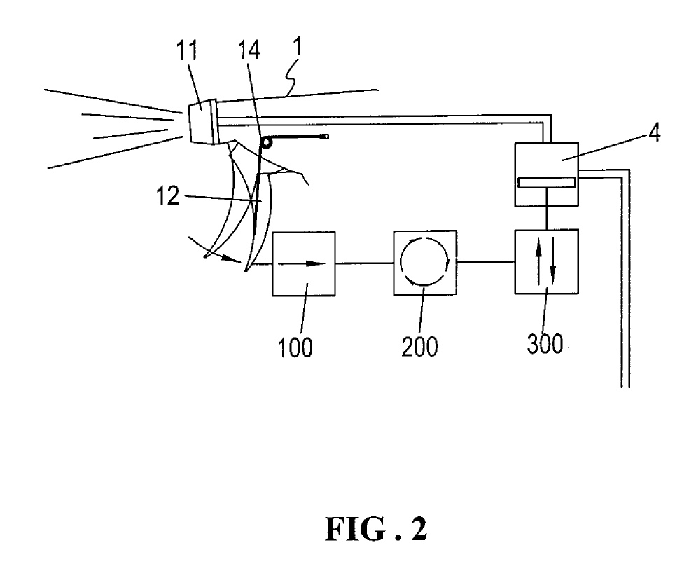

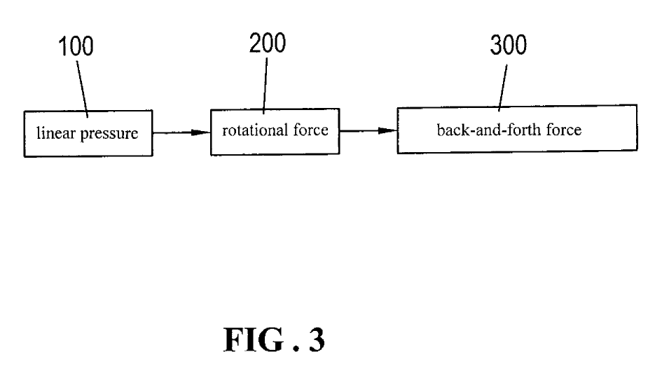

As shown in FIGS. 2 and 3, the method of the present invention in achieving continuous sprays is as follows. When a lever 12 of a sprayer 1 is exerted with a linear pressure 100, the linear pressure 100 is turned into a rotational force 200 whose direction is changed intermittently. The rotational force 200 in turn is converted into a back-and-forth force 300 on a pump 4 of the sprayer 1. Continuous sprays from a nozzle 11 are thereby produced.

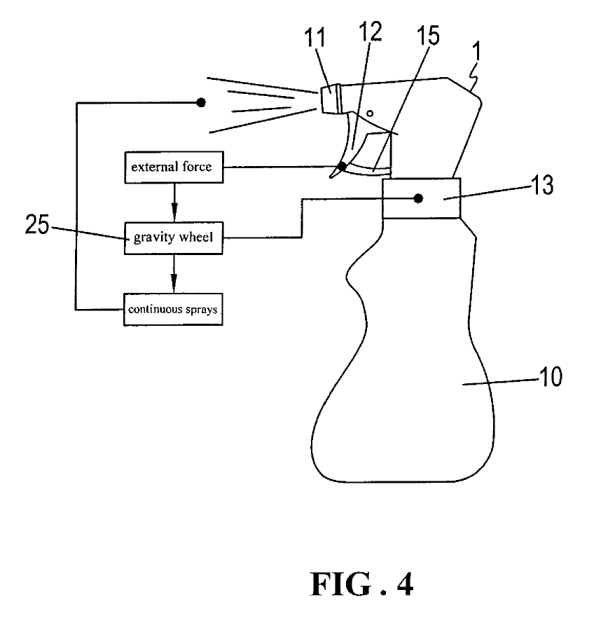

As shown in FIGS. 4 to 6, an automatic continuous sprayer 1 according to an embodiment of the present invention is mounted on a container 10 via a container cap 13 on a top opening of the container 10.

The sprayer 1 has a hollow and approximately L-like body. A nozzle 11 is provided on a front end of the sprayer 1 and the other end of the sprayer 1 is joined with the container cap 13. In addition, a curved first lever 12 is provided between the two ends of the L-shaped body. In turn, a curved second lever 15 has one end fixedly joined to a lower portion of the first lever 12 and the other end extended into a lower portion of the body of the sprayer 1. Please note that continuous teeth are provided along a top edge of the second lever 15.

A resilient element 14 is provided between the body and the first lever 12. In the present embodiment, a torsion spring is used as the resilient element 14 so that, after the first lever 12 is engaged to compress the resilient element 14 and then released, the first lever 12 is restored to its original, non-engaged position as the resilient element 14 expands.

Inside the body of the sprayer 1, the teeth of the second lever 15 engages a gear set 2, which in turn engages a rotatable piece 52 inside a gravity wheel 25. When a linear pressure is exerted on the first lever 12, the linear pressure is converted into a rotational force whose direction is changed intermittently, via the second lever 15, the gear set 2, and the gravity wheel 25.

To achieve that, inside the gravity wheel 25, there are a number of ratchets 51 around the inner circumference and the rotatable piece 52 is diametrically and pivotally mounted inside the gravity wheel 25. When the rotatable piece 52 is engaged by the gear set 2, the rotatable piece 52 spins inside the gravity wheel 25. A flexible block 53 is provided at the two ends of the rotatable piece 52, respectively, to interact with the ratchets 51. The ratchets 51, the rotatable piece 52, and the blocks 53 jointly form a clutch means 5.

The rotational force is further converted to a continuous back-and-forth force by an eccentric means 3. The eccentric means 3 contains an eccentric gear 31 engaged by the gravity wheel 25, and a T-shaped shaft 32 having an elongated hole 321 on one end connected to the eccentric gear 31. The shaft 32 has the other end directly pressed against a pump 4 also inside the body. As such, the rotation force on the eccentric gear 31 is converted into a back-and-forth movement of the shaft 32 and the pump 4 is continuously engaged by the shaft 32 to produce a number of sprays automatically.

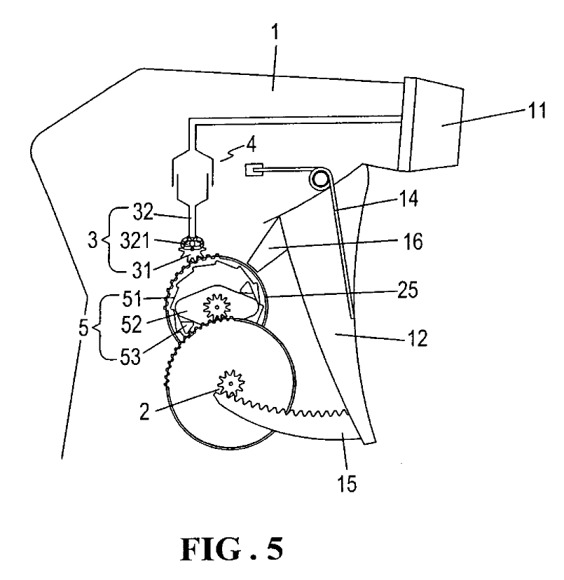

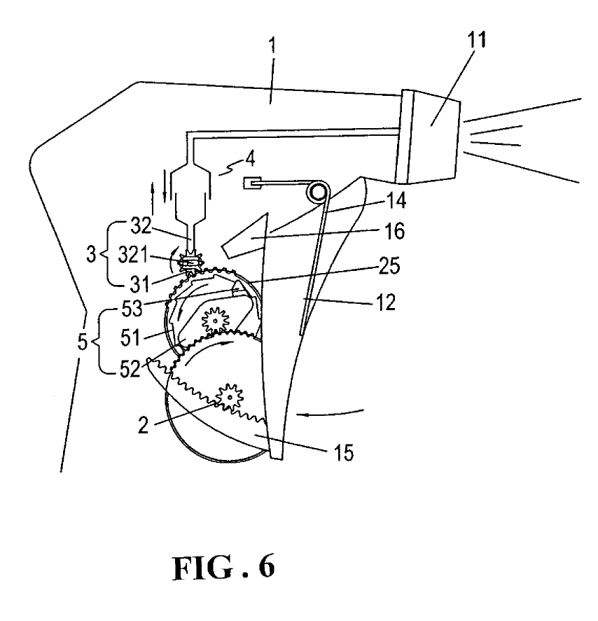

As shown in FIGS. 5 and 6, when a linear pressure is exerted to press the first lever 12 towards the body of the sprayer 1, the second lever 15 engages the gear set 2. As the rotatable piece 52 spins synchronously, the blocks 53 presses against some of the ratchets 51 and the gravity wheel 25 is rotated as well. As the gravity wheel 25 is turned, the blocks 53 may break away from the ratchets 51 and the gravity wheel 25 may turn freely in the opposite direction until the blocks 53 again press against some ratchets 51. The intermittent change of direction of the gravity wheel 25 further causes the eccentric means 3 to work on the pump 4 continuously as described above.

When the first lever 12 is released, as may be deduced from the drawings of FIGS. 5 and 6, the first lever 12 is restored to its original position by the resilient element 14 and the rotatable piece 52 of the gravity wheel 25 is turned in an opposite direction. However, due to that the blocks 53 are not blocked by the ratchets 51, the gravity wheel 25 does not engages the eccentric means 3.

As shown in FIGS. 5 and 6, the first lever 12 may further has a brake piece 16 extended into the body of the sprayer 1. The brake piece 16 is configured such that, when the first lever 12 is at its original position, the brake piece 16 has one end touching the circumference of the gravity wheel 25 to prevent the gravity wheel 25 from turning. When the first lever 12 is pressed, the brake piece 16 is turned away to allow the gravity wheel 25 to turn freely. Therefore, when the first lever 12 is released, the brake piece 16 will again touch the circumference of the gravity wheel to prevent it from working on the eccentric gear 31 to produce sprays.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the at without departing in any way from the spirit of the present invention.

I claim:

1. A method for controlling a sprayer, comprising the steps of: exerting a linear pressure on a lever of said sprayer;
converting said linear pressure into a rotational force of a wheel whose rotational direction changes intermittently by continuously engaging a clutch means;
converting said rotational force of said wheel into a continuous back-and-forth force of a shaft by continuously engaging an eccentric means; and
directing said back-and-forth force on a pump of said sprayer to produce a plurality of sprays.

2. The method according to claim 1, wherein said clutch means turns said wheel in a direction and then allows said wheel to turn freely in a reversed direction.

3. The method according to claim 1, wherein said eccentric means puts said shaft into a back-and-forth movement.

4. An automatic continuous sprayer, comprising:
an L-like body having a nozzle in a front end, a bottom end sealing a top opening of a container,
a first lever extended between said first and second ends of said body;
a resilient element between said body and said first lever capable of restoring said first lever back to an original position after said first lever is pressed and released;
a second lever having one end joined to a lower portion of said first lever and the other end extended into a lower portion of said body, said second lever having a plurality of teeth along an edge of said second lever;
a gear set inside said body engaged by said teeth of said second lever;
a gravity wheel inside said body engaged by said gear set, said gravity wheel having a clutch means so that when, engaged by said gear set, the rotational direction of said gravity wheel changes intermittently;
an eccentric means having an eccentric gear engaged by said gravity wheel and a shaft that is put into a back-and-forth movement by said eccentric gear;
a pump actuated by said shaft of said eccentric means to produce a plurality of sprays from said nozzle.

5. The sprayer according to claim 4, wherein said clutch means has a plurality of ratchets around the inner circumference of said gravity wheel, a rotatable piece diametrically and pivotally mounted inside said gravity wheel and engaged by said gear set, a flexible block is provided at two opposing ends of said rotatable piece, respectively, to interact with said ratchets so that said gravity wheel is driven in a direction by said gear set and then allowed to turn freely in a reversed direction.

6. The sprayer according to claim 4, wherein said shaft is T-shaped and has an elongated hole on one end of said shaft connected to said eccentric gear.

7. The sprayer according to claim 4, wherein said first lever has a brake piece whose one end is extended into said body of said sprayer, said end of said brake piece touches the circumference of said gravity wheel to prevent said gravity wheel from turning when said first lever is at a non-engaged position.

8. The sprayer according to claim 4, wherein said resilient element is a torsion spring.
